(19) United States
(12) Patent Application Publication
(10) Pub. No.: US 2024/0393165 A1
(43) Pub. Date: Nov. 28, 2024

(54) DISTRIBUTED FIBER OPTIC SENSING AND DETECTION SYSTEMS AND METHODS FOR IMPROVED DRILLING OPERATIONS AND WELL CONTROL

(71) Applicant: Board of Supervisors of Louisiana State University and Agricultural and Mechanical College, Baton Rouge, LA (US)

(72) Inventors: Jyotsna Sharma, Baton Rouge, LA (US); Mauricio Almeida, Baton Rouge, LA (US); Otto Santos, Baton Rouge, LA (US); Yuanhang Chen, Baton Rouge, LA (US); Mahendra Kumar Ramachandran Kunju, Baton Rouge, LA (US)

(21) Appl. No.: 18/696,226

(22) PCT Filed: Oct. 6, 2022
(86) PCT No.: PCT/US2022/077654

§ 371 Date: Mar. 27, 2024

Related U.S. Application Data
(60) Provisional application No. 63/253,726, filed on Oct. 8, 2021.

(51) Int. Cl. G01H 9/00; E21B 47/113; G01K 11/32; G01L 11/02; G01V 1/22

(52) U.S. Cl. CPC G01H 9/004; E21B 47/114; G01K 11/32; G01V 1/226; G01L 11/025; G01V 2210/1429

(57) ABSTRACT

The present disclosure provide systems and methods for well control. One such method comprises positioning a fiber optic sensor along a length of a wellbore or a wellbore structure positioned within the wellbore: obtaining fiber optic sensing data acquired by the fiber optic sensor and an optical interrogator: processing the fiber optic sensing data to identify a multiphase fluid flow or a gas signature of gas within the wellbore: tracking a movement of the gas along the length of the optical cable by determining a flow velocity of the moving gas or a lower density phase of the moving gas with respect to a surrounding fluid: detecting a presence of the moving gas towards a surface of the wellbore or a surface of the wellbore structure; and/or transmitting a control signal to a controller of machinery operating in the wellbore after detecting the presence of the moving gas.

### CROSS-REFERENCE TO RELATED APPLICATION

This application claims priority to co-pending U.S. provisional application entitled, “Distributed Fiber Optic Sensing and Detection Methods for Improved Drilling Operations and Well Control,” having Ser. No. 63/253,726, filed Oct. 8, 2021, which is entirely incorporated herein by reference.

### TECHNICAL FIELD

The present disclosure is generally related to well control techniques.

### BACKGROUND

Effective drilling and well control depends on the drilling teams' knowledge of wellbore flow dynamics and their ability to predict and control influx or kick of formation fluids. Conventional drilling and well control techniques primarily rely on detection techniques based on surface measurements and point sensors (or gauges) which only provide information at discrete locations on the surface or downhole. This can result in crucial gap of information in fully understanding the downhole flow dynamics along the length of the well, which can increase exposure to hazardous conditions during drilling, completion, and workover operations.

### SUMMARY

Embodiments of the present disclosure provide systems and methods for well control. One such method comprises positioning a fiber optic sensor along a length of a wellbore or a wellbore structure positioned within the wellbore, wherein the fiber optic sensor comprises an optical cable; obtaining, by a computing device, fiber optic sensing data acquired by the fiber optic sensor and an optical interrogator; processing, by the computing device, the fiber optic sensing data to identify a multiphase fluid flow or a gas signature of gas within the wellbore; tracking, by the computing device, a movement of the gas along the length of the optical cable by determining a flow velocity of the moving gas or a lower density phase of the moving gas with respect to a surrounding fluid; detecting, by the computing device, a presence of the moving gas towards a surface of the wellbore or a surface of the wellbore structure; and/or transmitting, by the computing device, a control signal to a controller of machinery operating in the wellbore after detecting the presence of the moving gas.

The present disclosure can also be viewed as a novel well control system. In this regard, one embodiment of such a system, among others, includes at least one processor; and memory configured to communicate with the at least one processor, wherein the memory stores instructions that, in response to execution by the at least one processor, cause the at least one processor to perform operations comprising: obtaining fiber optic sensing data acquired by a fiber optic sensor positioned along a length of a wellbore or a wellbore structure positioned within the wellbore, wherein the fiber optic sensor comprises an optical cable; processing the fiber optic sensing data to identify a multiphase fluid flow or a gas signature of gas within the wellbore or the wellbore structure; tracking a movement of the gas along the length of the optical cable by determining a flow velocity of the moving gas or a lower density phase of the moving gas with respect to a surrounding fluid; detecting a presence of the moving gas towards a surface of the wellbore or a surface of the wellbore structure; and/or transmitting a control signal to a controller of machinery operating in the wellbore after detecting the presence of the moving gas.

In one or more aspects for such systems and/or methods, the fiber optic sensor comprises a distributed acoustic sensor; the fiber optic sensing data comprises distributed acoustic sensor data; the fiber optic sensor comprises a distributed temperature sensor; the fiber optic sensing data comprises distributed temperature sensor data; the flow velocity is determined using a numerical model that simulates a bullheading operation occurring in the wellbore; the flow velocity is determined using a numerical model that simulates an injection line operation occurring in the wellbore; the flow velocity is determined using a numerical model that simulates a migration condition occurring in the wellbore; the flow velocity is determined using signal-to-noise analysis of the fiber optic sensing data, wherein the fiber optic sensing data comprises distributed acoustic sensor data; the flow velocity is determined using an analysis of an energy spectrum of the fiber optic sensing data, wherein the fiber optic sensing data comprises distributed acoustic sensor data; the flow velocity is determined using a frequency-wavenumber transform of a gradient of a frequency band energy of distributed acoustic sensor data over time; a frequency of the distributed acoustic sensor data is between 0 and 2 Hz; the flow velocity is determined using a 1D continuous wavelet transform of the energy spectrum; a frequency of the distributed acoustic sensor data is between 2 and 5000 Hz; the flow velocity is determined using an analysis of a difference plots for a temperature of the moving gas, wherein the fiber optic sensing data comprises distributed temperature sensor data; the controller is part of a control system for drilling operations of the wellbore; the controller is part of a control system for managed pressure drilling operations of the wellbore; and/or the control signal directs the controller to adjust an operational parameter of the machinery operating in the wellbore.

In one or more aspects, such systems and/or methods may further perform predicting, by the computing device, an arrival time that the gas will reach the surface of the wellbore based on the determined flow velocity.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a schematic arrangement of a typical fiber-optic system and the components of the backscattered light spectrum in accordance with the present disclosure.

FIG. 2A depicts a well schematic showing the location of the four downhole pressure and temperature gauges, a distributed acoustic sensor (DAS), and a distributed temperature sensor (DTS) in accordance with experimental trials of the present disclosure.

FIG. 2B depicts a schematic of a single-mode fiber for the DAS and a multimode fiber for the DTS in accordance with embodiments of the present disclosure.

FIG. 2C shows a table (Table 1) of data acquisition and sensor parameters of the sensors depicted in the well schematic of FIG. 2A.

FIG. 2D shows a table (Table 2) of flow parameters for experimental trials of the present disclosure.

FIG. 3 shows an exemplary computing environment in accordance with various embodiments of the present disclosure.

FIGS. 4A-4B provide comparisons between pressure estimated from a numerical model and pressure gauges for (A) trial A1 with gas injection through an injection line of the test well and (B) trial B4 with gas injection through a tubing of the test well in accordance with the present disclosure.

FIGS. 5A-5B provide plots of gas rise velocities estimated from a numerical model for (A) trial A1 and (B) trial A4 in accordance with trials of FIG. 2D.

FIG. 5C shows a table (Table 3) providing a summary of average gas rise velocities (in ft/s) for eight experimental trials of the present disclosure.

FIGS. 6A-6B provide plots of (A) pressure gauge measurements for trial A1 and (B) pressure differential between consecutive pressure gauges for trial B3 in accordance with the experimental trials of FIG. 2D.

FIGS. 7A-7B provide plots showing the effect of gas volume on (A) gas flow rate for trials A1 and A2 and (B) pressure for trials A1 and A2 in accordance with the experimental trials of FIG. 2D.

FIGS. 8A-8D provide DAS Band 0 (2-5,000 Hz) frequency band energy (FBE) waterfall plots for trials A1, A2, A3, and A4 in accordance with the experimental trials of FIG. 2D.

FIGS. 9A-9D show the gradient of low frequency (LF)-DAS (0-2 Hz) FBE waterfall plots for trials A1, A2, A3, and A4 in accordance with the experimental trials of FIG. 2D.

FIGS. 10A-10D show frequency-wavenumber (F-K) plots for LF-DAS FBE highlighting gas rise velocity for trials A1, A2, A3, and A4 in accordance with the experimental trials of FIG. 2D.

FIGS. 11A-11D show signal-to-noise (SNR) plots for DAS FBE (Band 0) for trials A1, A2, A3, and A4 in accordance with the experimental trials of FIG. 2D.

FIGS. 12A-12C show DTS difference plots for trials A1, A3, and A4 in accordance with the experimental trials of FIG. 2D.

FIGS. 13A-13D show DAS Band 0 (2-5000 Hz) FBE waterfall plots for trials B1, B2, B3, and B4 in accordance with the experimental trials of FIG. 2D.

FIGS. 14A-14D show gradient of LF-DAS (0-2 Hz) FBE waterfall plots for trials B1, B2, B3, and B4 in accordance with the experimental trials of FIG. 2D.

FIGS. 15A-15D show F-K plots for LF-DAS FBE highlighting gas rise velocity for trials B1, B2, B3, and B4 in accordance with the experimental trials of FIG. 2D.

FIGS. 16A-16B show SNR waterfall plots for DAS FBE (band 0) for trials B1 and B2 in accordance with the experimental trials of FIG. 2D.

FIGS. 16C-16D show SNR plots for DAS FBE (Band 0) for trials B3 and B4 in accordance with the experimental trials of FIG. 2D.

FIGS. 17A-17D present time-frequency scalograms using continuous wavelet transform of DAS data for trials B1, B2, B3, and B4 showing gas movement over time in accordance with the experimental trials of FIG. 2D.

FIGS. 18A-18D show DTS difference plots for trials B1, B2, B3, and B4 in accordance with the experimental trials of FIG. 2D.

FIG. 19 depicts a schematic block diagram of a computing device that can be used to implement various embodiments of the present disclosure.

### DETAILED DESCRIPTION

The present disclosure describes various embodiments of systems, apparatuses, and methods for detecting a presence of gas in a wellbore using fiber optic sensing. Such detection operations can be valuable in well control and other drilling applications.

A gas kick is an undesirable gas influx into the wellbore due to an underbalanced condition in which the pressure inside the wellbore is less than the formation pressure. If not detected and managed in time, a gas kick can result in environmental contamination and catastrophic blowout. Thus, detecting and monitoring for gas influx in a wellbore structure, such as a riser, has become more relevant now when considering, as a non-limiting example, the application of managed pressure drilling (MPD) operations in deep and ultradeep waters that may allow for a controlled amount of gas inside the riser, in addition to other well control applications.

The adoption and acceptance of Managed Pressure Drilling (MPD) is allowing operators to drill wells that were once thought of as impossible to drill due to tight margins. Use of MPD has allowed the industry to do uninterrupted drilling and other drilling related activities by making use of the MPD based on closed loop system. One of the areas lacking efficiency and safety improvements is the continued practice of stopping drilling and closing the Subsea Blowout Preventer (BOP) and isolate the riser when the presence of any gas in the well is suspected. Many valuable hours are spent looking for confirmation of gas presence which in many cases are not possible due to lack of proper instrumentation. By the time it takes to confirm the presence of gas by monitoring shut-in pressure build-up due to gas migration, the gas probably reaches very close to the surface and can result in an accident. All of these delays can be avoided with the use of fiber optics in the annulus. Operation can go uninterrupted by the continued use of the safer closed loop system MPD if the amount of gas influx is small instead of stopping operation for every instance of suspected gas presence or bypassing closed loop systems such as MPD.

Conventional kick monitoring methods-such as mud pit volumetrics, delta flow method, variations in annular discharge pressure and standpipe pressure-primarily rely on surface-based measurements, which are sometimes inadequate due to the monitoring lag and low metering precision. In many gas kick well control operations, the estimations of gas influx position are commonly based on experience. This may not be sufficiently reliable in challenging operations, such as drilling in offshore environments. Knowledge of gas rise velocity can provide a good estimation of how much time it will take for the gas to reach the surface and to mitigate that risk with a proper procedure in place. The lack of knowledge of the gas behavior in risers makes the industry methods to prevent offshore well control accidents be more conservative.

For instance, in the case of a gas kick occurrence, wellbore pressure control systems, such as Managed Pressure Drilling (MPD), allow for circulation of the gas from the well during continuing drilling of the well. However, due to the lack of understanding of gas behavior while circulating through the riser, some operators will establish high constraints on the volume of gas to be allowed in the riser and others simply will close the well as soon as the MPD system detects a kick. This results in not utilizing the full capability of the MPD which could reduce the total well control operation time and help in resuming drilling faster. In addition, reliable and early detection methods mean less volume of gas kick to be handled by the rig personnel, which allows immediate actions to be taken, minimizing the risk of losing control of the well.

In recent years, distributed fiber optic sensors (DFOS) such as Distributed Temperature Sensor (DTS), Distributed Acoustic Sensor (DAS), Distributed Strain Sensor (DSS), and Distributed Pressure Sensors (DPS) have been viewed as promising technology for real-time downhole monitoring. DFOS can be installed in a wellbore or on offshore risers to provide real-time information about temperature, pressure, strain, and vibrations that can be used for modeling and interpretation of fluid flow dynamics simultaneously along the entire length of the fiber in real-time. They have been successfully demonstrated for monitoring in both onshore and offshore wells for production and injection profiling, seismic acquisition, fracture monitoring, leak detection, well integrity monitoring, etc. However, the use of DFOS sensors, such as DTS and DAS sensors, for drilling and well control applications have not been previously demonstrated.

Accordingly, the present disclosure provides systems and methods for the novel use of DTS and DAS sensors for improving well control by monitoring gas influx in a wellbore. DFOS is a valuable real-time downhole sensing technology for well control such as for early kick detection since it can be deployed outside of the marine riser at working conditions with minimal interference with system performance and dimensions. By providing temperature, vibration, strain, and/or pressure information simultaneously in real-time along the entire length of the cable along the well at high temporal and spatial resolution, exemplary distributed fiber optic sensors of the present disclosure overcome a key limitation of gauges, point sensors, and logging tools, which only provide data at one location at a time, which results in a deficiency of crucial data. Fiber optic data gives insights to complex physical effects and process dynamics in real-time along the entire length of the installed fiber. Fiber optic sensors offer many advantages compared to conventional gauges and offer higher reliability for long-term deployment that include being chemically passive, electrically insulating, immune to corrosion, having the ability to withstand high temperature and pressure conditions, being non-intrusive (due to small fiber diameter), being fast and more sensitive since they use light to convey the information, etc. Because of the demands for chemical and electrical passivity, transmission lengths, and operational robustness, fiber-optic sensing methods are an excellent way of monitoring downhole systems.

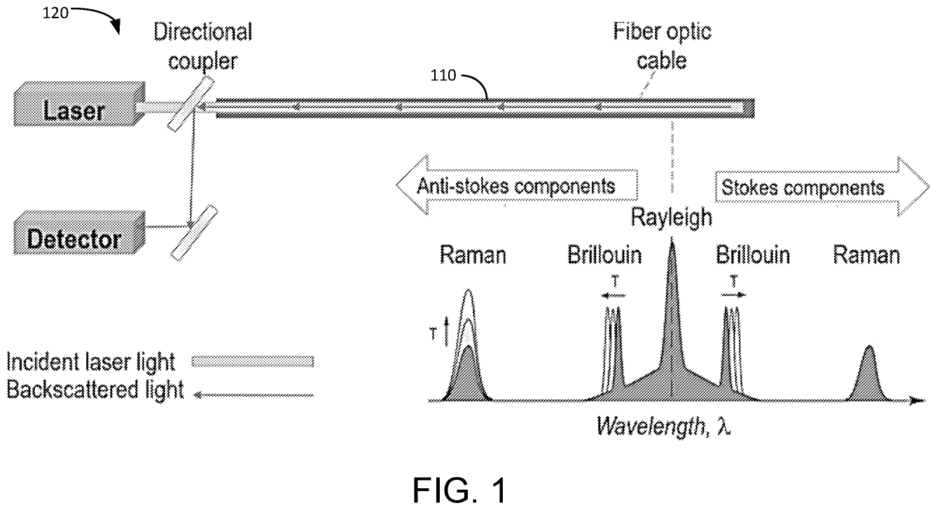

Distributed fiber-optic sensing systems utilize the principle of coherent optical time domain reflectometry (OTDR). A typical set-up contains a light source (laser), optical fiber 110, and detector as shown in FIG. 1, where an optical interrogator system 120 may be comprised of the light source and detector components. Continuous laser pulses are launched into the installed fiber cable 110. As the light travels through the core of the fiber (typically made of glass), a portion of the photons that interact with the glass medium are scattered backwards and picked up by the detector. Scattering is caused by the interaction of the laser light with density fluctuations within the fiber 110. The density changes are the impurities produced when the optical fibers are manufactured. The light's backscattered spectrum includes Rayleigh, Raman, and Brillouin bands, as shown in FIG. 1. The changes in the back-scattered light can be related to the acoustic, vibration, pressure, strain, and thermal variations along the fiber 110. The fiber optic measurements widely used today are DAS, DTS, and Distributed Strain Sensing (or DSS).

The DTS utilized in various embodiments of the present disclosure processes the Raman Stokes and anti-Stokes wavelength bands of the spectrum to estimate the distributed temperature profile along the entire fiber 110. Correspondingly, in various embodiments, the DAS system uses a heterodyne distributed vibration sensor (hDVS) technique based on the Rayleigh backscattered light. Knowing the properties of the fiber, the time of flight for the laser pulse is converted into distance that enables an estimation of a position of a measurand perturbation.

A variety of time- and frequency-domain signal processing techniques are developed to analyze the fiber-optic data to optimize gas detection using DTS and/or DAS sensors. The knowledge of the position and the velocity of a gas kick can be critical in a well control operation. While the majority of the conventional kick detection techniques rely on surface measurements and data from point sensors or gauges that only provide information at discrete locations, the present disclosure presents comprehensive results from well-scale experiments of systems and methods of the present disclosure that demonstrate the application of downhole distributed fiber-optic sensors for real-time monitoring of gas influx in a 5,163-ft-deep wellbore as provided in the following discussions.

In accordance with the present disclosure, fiber-optic DAS and/or DTS can be applied for early detection of the source of gas kicks by monitoring its movement and flow patterns (e.g., a lower density phase with respect to surrounding fluid(s)) as it rises to the surface in real-time and predicting the gas arrival at the surface by measuring its flow velocity. In certain embodiments, DAS and DTS can be both provided as redundant detection techniques for detecting gas kick sources during active wellbore operations, such as, but not limited to, drilling of a wellbore. In accordance with various embodiments of the present disclosure, fiber-optic data is analyzed using novel signal processing techniques to optimize gas detection, including DAS frequency band energy (FBE) extraction for high-frequency (2-5,000 Hz), low-frequency gradient plots (<2 Hz), frequency-wavenumber (or F-K) transform, DAS energy spectrum, DTS difference plots, and real-time visualization. To this end, a series of gas (nitrogen)-water flow tests were conducted in the 5,163-ft-deep experimental well at the Petroleum Engineering Research, Training, and Testing (PERTT) lab facility at Louisiana State University (LSU). The goal was to understand the gas rise behavior and the well-scale flow dynamics for different gas kick volumes (2 bbl to 15 bbl), water circulation rates (0 to 200 GPM), and injection methods (through tubing or ½-in. injection line).

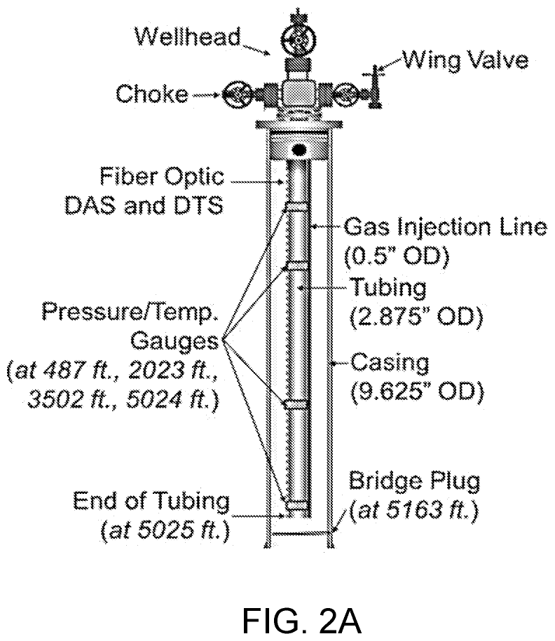

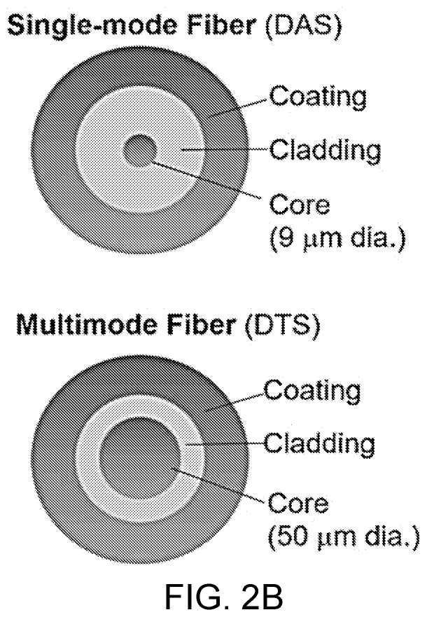

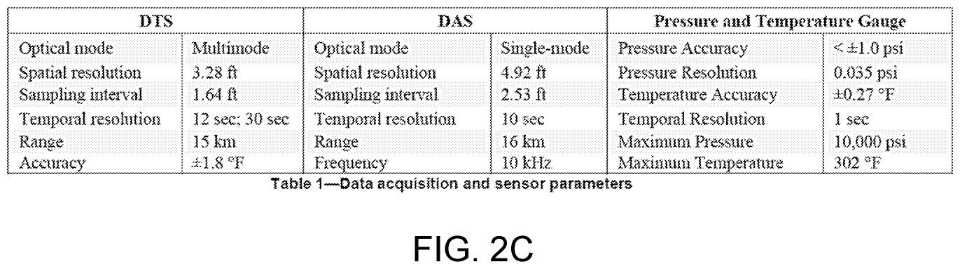

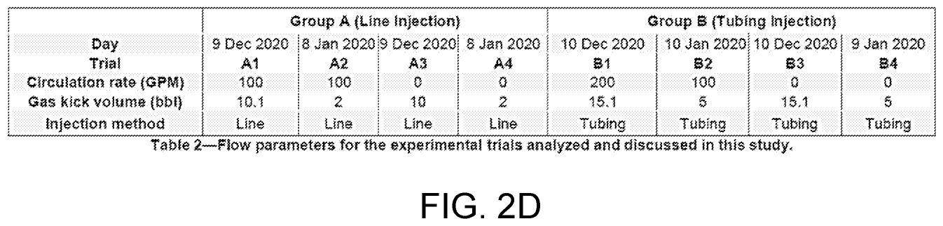

PERTT lab is a one-of-a-kind research facility for the development, integration, and testing of technologies used in the oil and gas industry. There are six wells, up to 5,800 ft in depth that provide a unique full-scale environment to test downhole equipment at pressures up to 4,000 psi and field-scale surface equipment. The test well was instrumented with DAS and DTS, which were clamped to the outside of the tubing. The wellbore replicates a field-scale oil and gas well with 9.625-in outer diameter (OD) casing and 2.875-in OD tubing up to 5,025 ft. There are four downhole pressure and temperature gauges that read measurements in the annulus and a ½-in. capillary gas injection line strapped to the tubing, as shown in FIG. 2A. A single-mode optical fiber was used for DAS acquisition and a multimode optical cable was used for DTS measurements, as illustrated in FIG. 2B. The specifications of the DAS, DTS, and the downhole pressure and temperature gauges are summarized in Table 1 (FIG. 2C).

The wellbore was initially filled with water, and a fixed volume of nitrogen gas was injected (the “kick volume” measured in barrels) either down the tubing or down the gas injection line strapped outside the tubing (shown in FIG. 2A). In some of the tests water was circulated at a fixed circulation rate (measured in GPM), while a constant surface backpressure was attempted to be maintained on the wellhead choke by manually adjusting it. Some tests were conducted with no water circulation to monitor gas migration in a static water column, with a constant backpressure. DAS, DTS, and downhole pressure gauge data from eight trials are analyzed to characterize gas migration and estimate gas rise velocity in the annulus (where the eight trials were conducted over two test periods, referred to as Period 1 and Period 2, and the objective of the tests occurring over Period 1 was to understand the effect of the higher gas kick volume (up to 15 bbl) on the DAS, DTS, and gauge data and compare them with the tests over Period 2 that utilized a smaller gas influx volume (up to 5 bbl)).

The eight tests within Period 1 and Period 2 represent different kick volumes (2 to 15 bbl), water circulation rates (0 to 200 GPM), and injection methods (Group A trials representing gas injection through the ½″ injection line and Group B trials representing gas injection through the tubing), as summarized in Table 2 (FIG. 2D). After the gas slug injection, either the gas was circulated out of the well with the water flow rates shown in Table 2 (FIG. 2D) for trials A1, A2, B1, and B2 or it was left in the well to migrate to the surface inside the closed well under stagnant or non-circulation conditions as can be seen in Table 2 (FIG. 2D) for trials A3, A4, B3, and B4 where the flow rates are shown to be zero.

Due to the enormous amounts of data produced by the DAS systems, which can be in the order of terabytes per hour for an average well length, it is important to have a strategy for management, processing, and visualization of the streaming data in real-time. Latency is also an important consideration because the usefulness of sensor data is often lost if not used immediately, particularly for near-real-time decision making, such as in automation of well-control. Various computing systems, such as, but not limited to, cloud-based computation ecosystems can help bridge the gap as they are capable of processing and storing voluminous data.

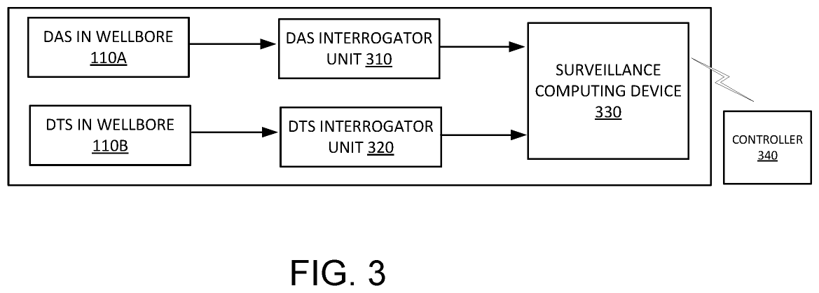

In an exemplary computing environment of FIG. 3, DAS and DTS surface interrogators units 310, 320 were connected to the single-mode fiber cable 110A and multimode fiber cable 110B, respectively, at the wellhead (FIG. 2B). The interrogator units 310, 320 transmit the acquired data to a surveillance computing device 330 such that the computing device 330 can display streams of the DAS and/or DTS downhole data. In particular, the surveillance computing device 330 can visually represent and track a gas signature along a length of a wellbore as an influx of gas moves within the wellbore to an operator of the well and/or can generate control signals to machinery operating within the well, such as, but not limited to, a drill assembly, based on the detection of one or more gas influxes or other conditions within the well using disclosed gas detection methods of the present disclosure. Accordingly, the surveillance computing device 330 can be in electronic communication with a controller device 340 and send control or operational parameters to the controller device 340 that will allow for operation of machinery in use within the well to be adjusted based on conditions, such as rising gas conditions, detected by the surveillance computing device 330. Such adjustments can occur in real-time and during active operations of the machinery.

Sample applications of systems and methods of the present disclosure include the installation of DAS fiber optic sensors on wellbores structures, such as drilling riser, MPD surface lines, or intermediate or surface casing, to record acoustic signatures that can be correlated to anomalies or problems in the well using pattern recognition algorithms; use of DAS fiber optic sensors in a relief well as a ranging tool to pinpoint the direction and distance to a blowout well; use of DAS fiber optic sensors in the well to record vibration signatures that can be correlated to malfunctions of the drilling string and bit performance and/or can be used to determine drill string stuck points; and evaluation of the well cleaning status detecting acoustic signatures that correlate to cutting transportation patterns. Sample applications of systems and methods of the present disclosure further include use of DTS fiber optic sensors to detect leaks or holes in wellbore structures, such as the drill string and in casing or liner strings; and detection of a cement top just after a cementing job. Asides from drilling applications, sample applications of systems and methods of the present disclosure also include the use of fiber optic sensors to detect stranded oil between two wells, where the fiber optic cable runs inside a well while an acoustic source runs in the other well; and the installation of a fiber optic sensor on motors to detect vibration signatures than can anticipate possible mechanical failures using pattern recognition algorithms.

The ability of the optical fiber sensors 310, 320 to provide accurate and repeatable information depends on the quality of the signal returning from the point of interest, optical losses, and the system noise. There are several types of noise sources for a distributed fiber-optic system related to the various components used within an optical interrogator system. This includes the laser noise, local oscillator noise, quantification noise from the digitization of optical data, and fading noise.

Considering the magnitude and the permanent occurrence of the different noise sources described above, except for the fading, which is statistically infrequent, a straightforward SNR estimation approach was adopted to quantify the effect of the gas kick volume and migration on the DAS measurements. Because the objective was to estimate gas rise velocity, the “signal” of interest for the SNR calculation was selected as the DAS FBE traces at different timesteps during the gas rise in the annulus. The FBE inherently provides a measure of the energy of the DAS vibration. This “signal” was compared against a reference DAS FBE trace (or the “noise”) which was selected about an hour after the gas had completely migrated out of the wellbore, while similar operating conditions or parameters (such as circulating rates, choke position, and pump speed) were maintained. The reference “noise” FBE will naturally include the effect of all the noise sources discussed above which are always present, in addition to the background noise caused by the wellbore flow, but not including the effect of gas injection which is the target “signal” for this SNR analysis. These instrument noise sources are also present during gas injection, however because they are of a much lower order of magnitude compared to the vibration caused by the gas injection, they can be neglected.

Gas velocities estimated independently from the fiber-optic DAS and DTS were validated with a numerical model that applies two-phase flow correlations and with the data from the downhole pressure gauges. The methodology developed to model the experimental runs is based on the numerical solution of a system of five equations for the unsteady flow of a two-phase flow mixture (nitrogen and water) in a test well. One of the variables derived upon the solution of the equations system is the gas velocity as a function of time and position (depth) in the well. Gas velocities were also estimated using information from downhole pressure sensors installed in the test well.

The five-equation system comprises of the continuity equation for the liquid phase; continuity equation for the gaseous phase; momentum balance equation for the two-phase mixture; equation of state for the gaseous phase; and an empirical correlation between gas and liquid velocities (gas slip velocity). The numerical solution of this equation system yields five dependent variables (flow properties) for any time and position in the test well: pressure, liquid velocity, liquid hold-up, gas density and—important for this disclosure—gas velocity. The following discussion will only present the equations directly related to the gas rise velocity, specifically the one for the bubble flow, the prevailing two-phase flow pattern verified in the experiments. The gas rise velocity (Vg, in ft/s) is represented as follows:

$${V}_{g} = {Cv}_{l} + {v}_{s} \qquad ( 1 )$$

where, C is the dimensionless velocity profile coefficient (regarded as 1.0 here) and vₗ (in ft/s) is the liquid phase velocity. The gas slip velocity, vₛ (in ft/s), can be represented by Harmathy's equation (Harmathy 1960) as follows:

$${v}_{s} = 0.4774 {( \frac{σ ( {ρ}_{l} - {ρ}_{g} )}{{ρ}_{l}^{2}} )}^{0.25} {H}^{0.5} \qquad ( 2 )$$

where, σ is the gas/liquid surface tension in dyne/cm, pₗ and p_{g} are respectively the liquid and gas densities, both in lb/gal, and H is the liquid hold-up (dimensionless). The gas (nitrogen) density is given by:

$${ρ}_{g} = \frac{0.3 \; 61 p γ}{T Z} \qquad ( 3 )$$

where p is nitrogen pressure in psia, γ is the nitrogen specific gravity (0.967), Tis the gas temperature in *R, and Z is the nitrogen compressibility factor.

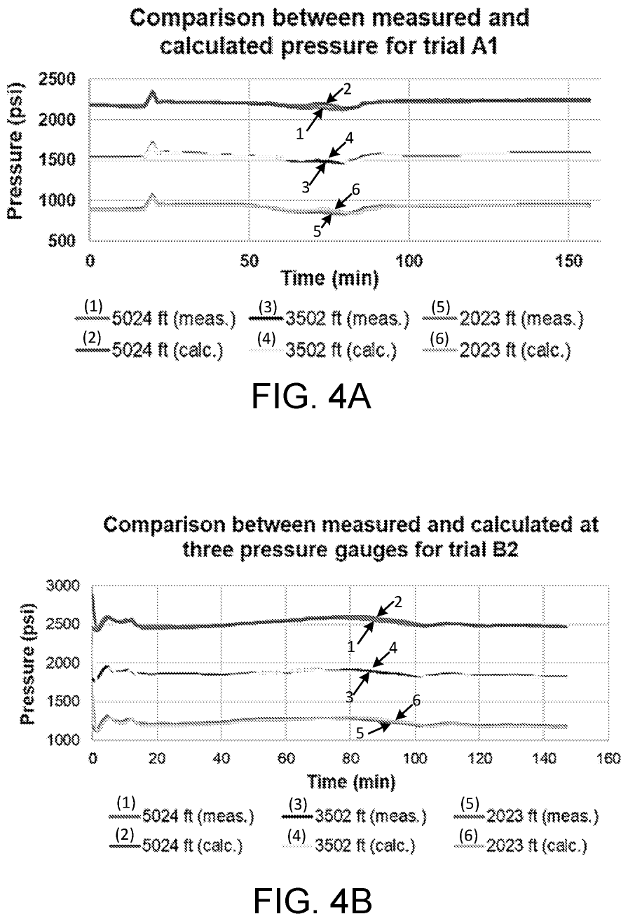

To validate the results of the two Fortran computer programs described above, the pressure predicted by the numerical model was compared to those measured by the downhole pressure gauges at three locations. FIG. 4A shows the pressure comparison for trial A1 where is gas was injected down the injection line, while FIG. 4B shows the pressure comparison for trial B4 where gas was injected down the tubing. Good agreement between measured and predicted pressure values was observed confirming the appropriateness of the two computer programs for injection down the line and the tubing (e.g., bullheading operation).

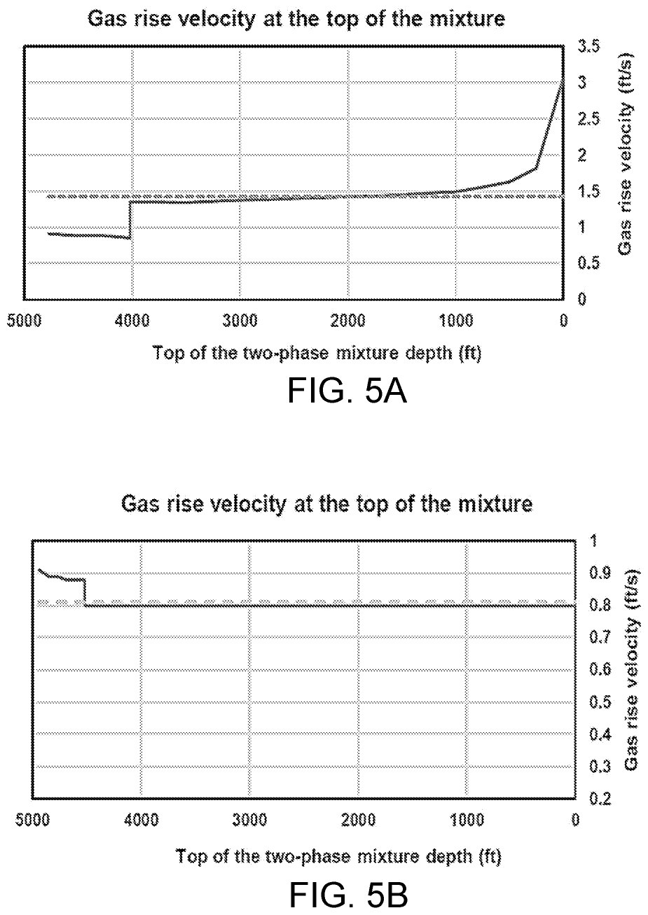

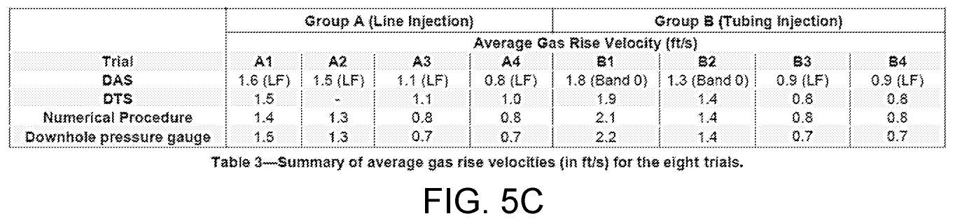

The gas rise velocities for the experimental runs that circulated the gas out of the well after the downhole nitrogen injection were also calculated using the two Fortran computer programs. For trials A1 and A2, the Fortran computer program for the line injection was utilized; for trials B1 and B2, the other Fortran program for nitrogen tubing injection followed by a bullheading operation was utilized. Trial A1 (with 10.1 bbl of nitrogen injected through the injection line and circulated out of the well with a water flow rate of 100 GPM) has been chosen to illustrate the application of the line injection computer program. FIG. 5A shows the simulated results for gas rise velocities at the top of the two-phase mixture. In the beginning, the gas moved slower because it corresponds to the period in which the gas was injected through the injection line. When the two-phase mixture reached approximately the depth of 4,020 ft, the gas injection was discontinued, and the pump was turned on to displace the gas with water at a flow rate of 100 GPM. The gas rise velocity increased while it traveled upward due to gas expansion and reached the surface at a value of approximately 3.0 ft/s. The gas velocity values displayed on the graph were averaged to produce an average velocity of 1.42 ft/s plotted on the graph as a dashed line. The computer program for gas injection down the tubing string and subsequent bullheading operation was used for trials B1 and B2. The results for all runs are summarized in Table 3 (FIG. 5C) in the row “Numerical Procedure.”

To model the gas migration phenomenon in a closed well with no water circulation (trials A3 and A4 for line injection, and B3 and B4 for tubing injection), the following numerical procedure was used to estimate the gas rise velocities. One of existing Fortran computer programs is used depending on the way that the gas is injected in the well (line or tubing injection) up to the moment at which the gas injection ends. Afterwards, Equation 2 is used to find the gas rise velocity in stagnant conditions (liquid velocity zero), again considering a gas average density of 0.9 lb/gal and a liquid holdup equal to 0.9. Trial A4 was chosen to illustrate the application of the calculation procedure. According to the simulation, after the gas has been injected for 10 minutes, it reached the depth of 4,522′ in the annulus. After the nitrogen injection has been finished, it migrated upward at a velocity of 0.8 ft/s calculated by Equation 2. So, the average gas velocity considering these two periods (gas injection and gas migration) is calculated to be 0.81 ft/s that is represented in FIG. 5B as a dashed line. This value, along with those calculated for trials A3, B3, and B4 (with no water circulation) using the same calculation procedure are presented in Table 3 (FIG. 5C) in the row “Numerical Procedure.”

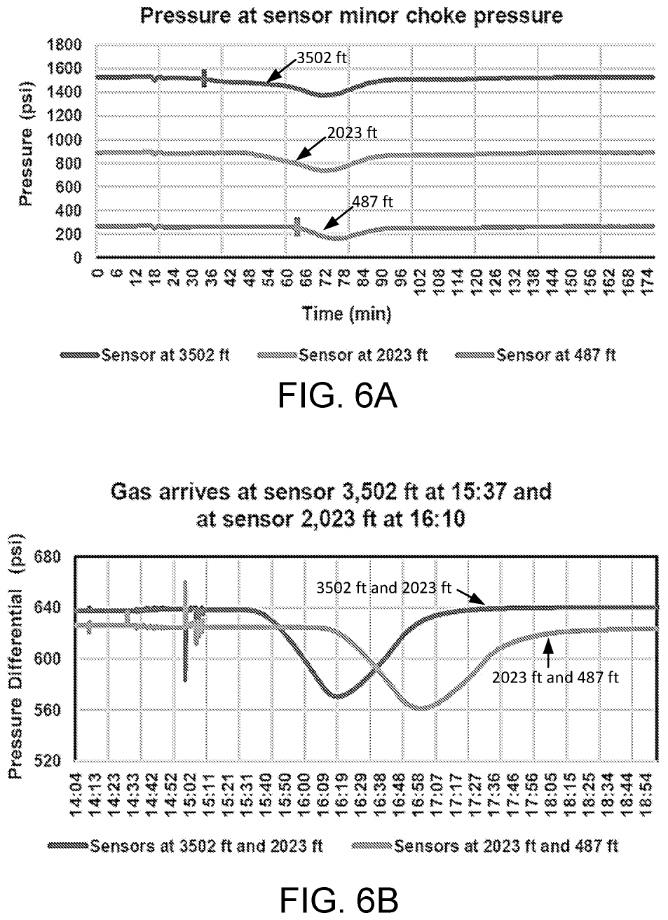

The gas rise velocities were also estimated using the downhole pressure gauge readings. FIG. 6A shows three downhole pressure sensor measurements at their respective depths 3,502 ft, 2,023 ft, and 487 ft subtracted from the choke pressure at a certain circulation time for trial A1. This subtraction improved the identification of the moment that the gas reached a certain pressure sensor. When this event happened, the pressure reading value started reducing since the hydrostatic pressure between the sensor and surface decreased or dropped because of the presence of gas above the sensor and the surface backpressure was kept almost constant. In FIG. 6A, the top of the gas passed in front of sensor at 3,502 ft at 31 minutes from the beginning of gas injection and after 64 minutes in front of sensor at 487 ft. Since the distance between the two pressure sensors is known (3,015 ft), the calculated average gas rise velocity was 1.52 ft/s. This value and the ones calculated for the trials A2, B1, and B2 using the same approach are shown in Table 3 (FIG. 5C), in the row “Downhole Pressure Gauge.”

For the trials where the gas was left in the closed well to migrate to surface (trials A3, A4, B3, and B4), another approach was used since for some trials it was difficult to notice the onset of the pressure reduction at a particular sensor when the gas reached the sensor depth as previously described. Now, the pressure differentials between two consecutive sensors are plotted as a function of migration time as shown in FIG. 6B for trial B3. In that figure, the top curve represents the pressure differential between pressure sensors at 3,502 ft and 2,023 ft of depth. The onset of the pressure differential reduction in the curve represents the moment at which the gas reached the downhole pressure gauge at 3,502 ft around 15:37 (3:37 p.m.). The differential pressure reduction after that moment is a result of the decrease of the hydrostatic pressure due the presence of gas between the two pressure sensors. The bottom curve in FIG. 6B shows the pressure differential between gauges at depths of 2,023 ft and 487 ft. It can be seen in FIG. 6B that the gas reached the gauge at a depth of 2,023 ft at 16:10 (4:10 p.m.). Since the lapse of time between these two moments was 33 minutes and the distance between the two points is 1,479 ft, the gas velocity between the two points was calculated to be 0.74 ft/s.

Using the same approach, the estimated velocities between these two pressure sensors (3,502 ft and 2,023 ft) for trials A3, A4, and B4 are respectively 0.73 ft/s, 0.73 ft/s, and 0.74 ft/s, as shown in Table 3 (FIG. 5C). This work only calculated the gas velocities between gauges at depths of 3,502 ft and 2,023 ft because the quality of data needed for the estimation of the moment at which the gas reaches the gauge at 487 ft was unsatisfactory. This could be because of the effect of gas dispersion at shallower depth.

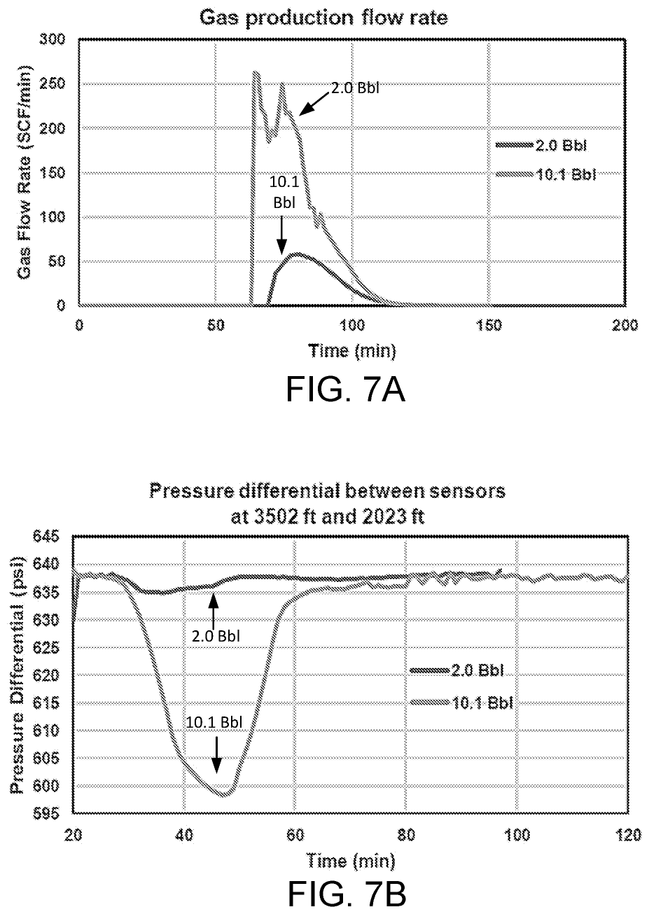

The gas rise velocities calculated using the foregoing approaches show a good agreement with those estimated from the DAS and DTS data, as discussed below. One observation from these experimental runs is that the volume of gas injected in the well contributes only moderately for an increase of the gas rise velocity under the conditions used in the experiments, as can be seen in Table 3 (FIG. 5C). However, the effect of this parameter is important on other flow variables such as gas flow rate flowing out of the well and pressure. FIG. 7A shows the comparison between the gas production flow rate calculated by the Fortran program for an initial volume of nitrogen injected through the injection line of 2.0 bbl (trial A2) and 10.1 bbl (trial A1). In the figure, 10.1 bbl of nitrogen has yielded a gas production flow rate peak five times greater than the one produced by 2.0 bbl of nitrogen. The irregular shape of the 10.1 bbl gas production flow rate curve results from manipulations of the choke during the gas production out of the test well when running trial A1. FIG. 7B shows the effect of gas volume on the pressure differential between the downhole pressure gauge readings at depths of 3,502 ft and 2,023 ft during trials A1 and A2. As expected, the volume of gas between the two sensors is much greater for trial A1 (10 bbl kick) when compared with the situation existing for trial A2 and therefore a larger pressure differential is observed for trial A1.

Next, the DTS and DAS data from the eight experimental trials summarized in Table 2 (FIG. 2D) are analyzed and compared. Accordingly, a fixed volume of nitrogen slug (or kick) was injected down the injection line (Group A trials) or the tubing (Group B trials), and a distinctive pattern or the gas signature, as it rises upwards in the wellbore annulus in a circulating or static water column (specified by the water circulation rate in Table 2 (FIG. 2D)), was monitored using the DAS and DTS. The data collected in the Period 1 tests at higher gas kick volumes (up to 15 bbl), was compared with the DAS and DTS data from the Period 2 tests with lower slug volumes (up to 5 bbl). The flow noises caused by measurements are common in the real life when using fiber-optic sensors. To distinguish the signature of interest from the noise, a variety of frequency-domain signal processing techniques were utilized. The time-domain raw data from DAS was processed to obtain frequency band energy (FBE) through the application of fast Fourier transforms (FFT). To further analyze the signal and noise amplitudes present in the DAS data, the root-mean-square (RMS) method based on Parseval's theorem was applied on the phase SEGY data to create an energy spectrum. The energy spectrum helps in identifying the frequency bands of interest for further analysis. Based on the acoustic characteristics observed in the energy spectrums for the test experiments, DAS high-frequency (2-5,000 Hz) and low-frequency (0-2 Hz) bands were selected for further investigation and processing. In accordance with various embodiments of the present disclosure, gas velocity was estimated using the frequency-wavenumber (or the F-K) transform of the gradient of the LF-DAS data with respect of time. To apply the F-K transform, a moving window is used over the vibration data (FBE) to perform 2D FFT in which the time sampling defines the frequency range, while the depth sampling defines the wavenumber range. In the following discussion, the gas rise velocity from LF-DAS is compared with the gas rise velocity from DTS data and the results from numerical modeling and pressure gauge analysis (as previously discussed). SNR analysis of DAS is presented for the eights tests and the effect of gas kick volume, water circulation rate, and injection method on the gas signature, rise velocity, and DAS sensitivity are discussed below.

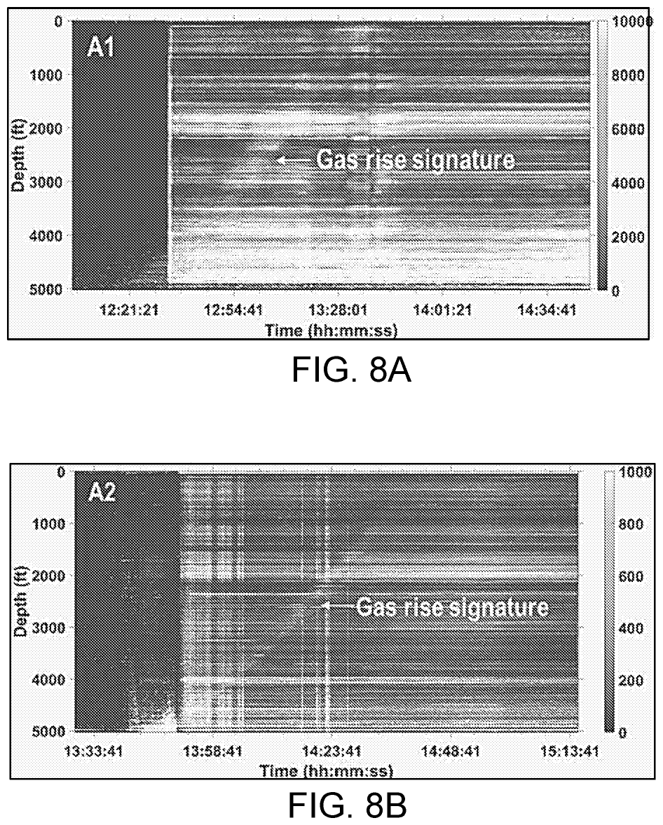

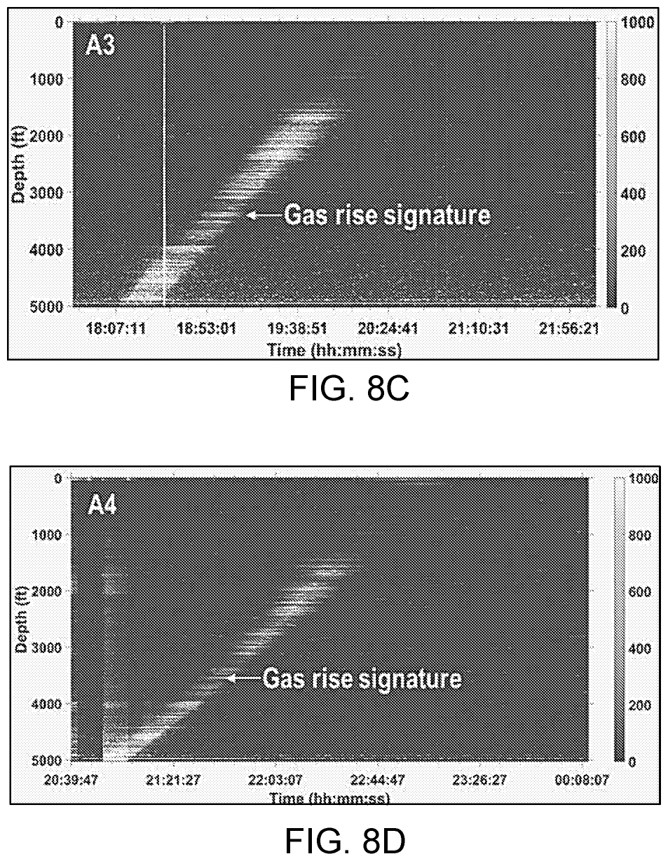

In the Group A trials, nitrogen was injected down the ½-in. gas injection line that is strapped to the outside of the production tubing (see FIG. 2A). DAS Band 0 (2-5,000 Hz) FBE data for trials A1 through A4 are shown in the FBE waterfall plot of FIGS. 8A-8D, where for a colorized depiction of the waterfall plot, the color corresponds to the intensity of the spectral power of the acoustic signal in the specific frequency range. A focus for the present disclosure is to analyze the signature of the gas rising in the annulus that can be used for early gas kick detection. Gas rise in the annulus can be seen clearly in FIGS. 8A-8D for all four trials using DAS FBE in Band 0 (2-5,000 Hz). However, in trials A3 and A4 the gas signature is clearer as the water column is static while in trials A1 and A2 the water circulation creates a high-energy acoustic/vibration effect in the background, making it more difficult to visualize the rising gas. The first arrival of gas at the surface is not very clear in FIGS. 8A-8D as the gas slug becomes increasingly dispersed at shallower depths as the pressure is lower and the slug breaks into bubbles. A higher gas kick volume results in a thicker gas signature which is evident for trials A1 and A3 (with 10 bbl kick) versus trials A2 and A4 (with 2 bbl kick) in FIGS. 8A-8D.

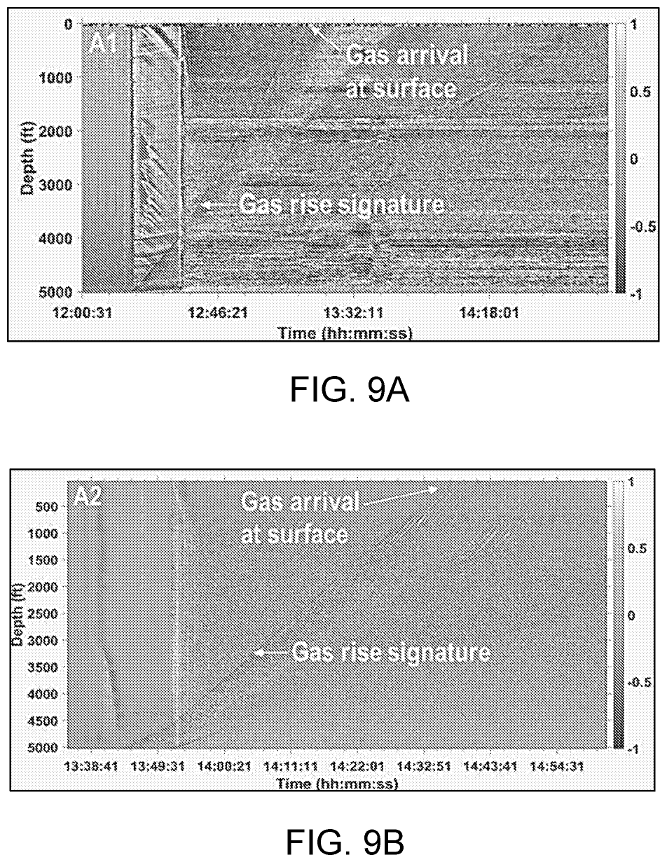

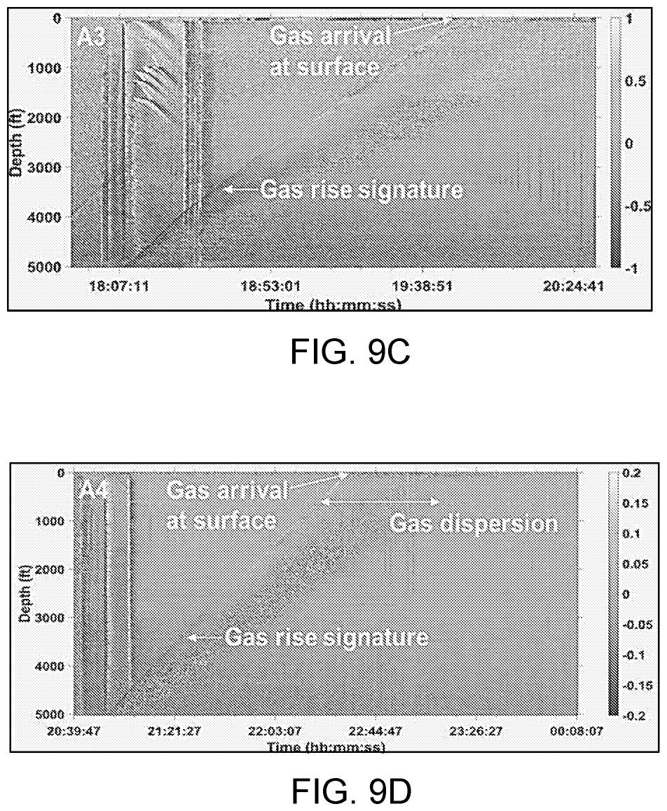

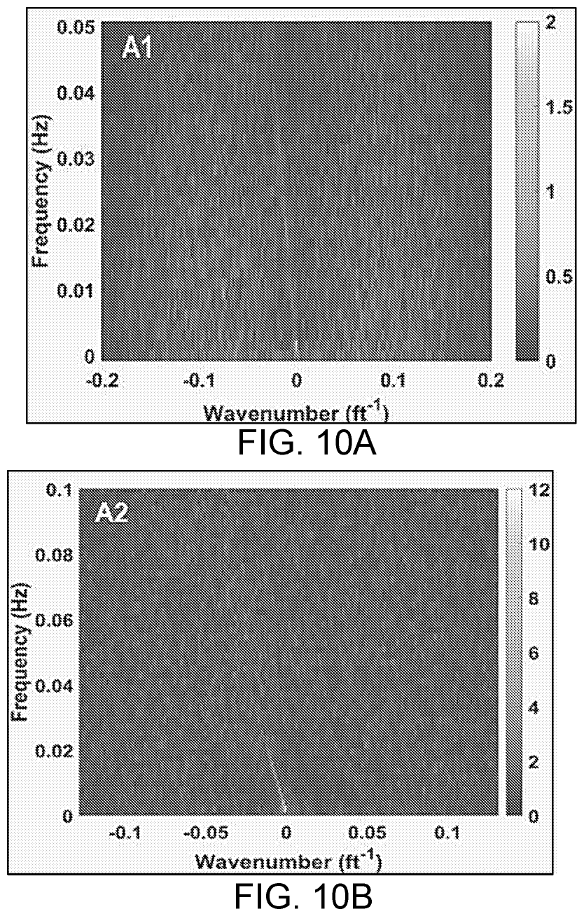

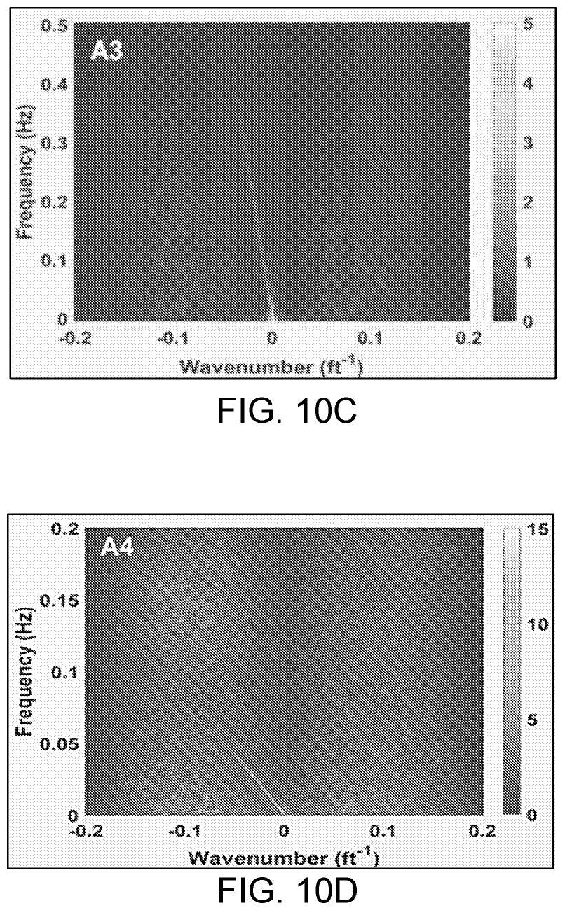

The gradient of the LF-DAS (0-2 Hz) with respect to time for the four trials is shown in FIGS. 9A-9D. The first arrival of gas at surface is seen more clearly in the lower frequency as compared to Band 0 FBE plots (FIGS. 8A-8D). However, the gas signature in LF-DAS is less clear for trial A1 due to the effect of water circulation (at 100 GPM) combined with the higher gas volume (10 bbl) which contribute higher frequency components. The dispersion of the gas slug as it travels upward is also seen more clearly in the LF-DAS, as compared to high-frequency data in FIGS. 8A-8D. The average gas rise velocities for all trials were calculated from the slope of the F-K transform of the LF-DAS gradient data which are shown in FIGS. 10A-10D and the calculated velocities are summarized in Table 3 (FIG. 5C) in the row “DAS.” The F-K transforms represent the average gas rise velocity along the well (as the velocity is also a function of the depth). Higher gas velocity is observed for trials A1 and A2, as compared to A3 and A4, primarily due to the water circulation in A1 and A2. The gas velocity is not significantly impacted by the gas volume.

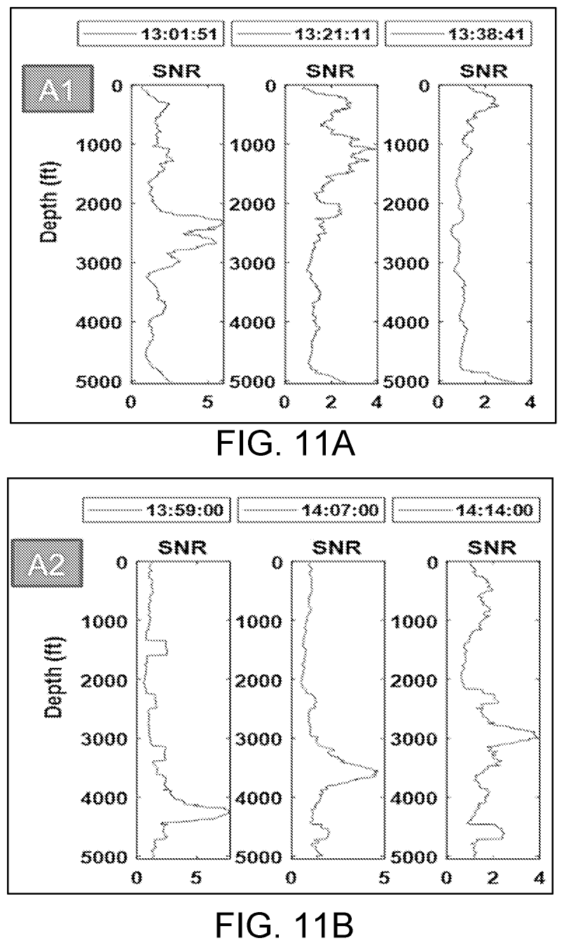

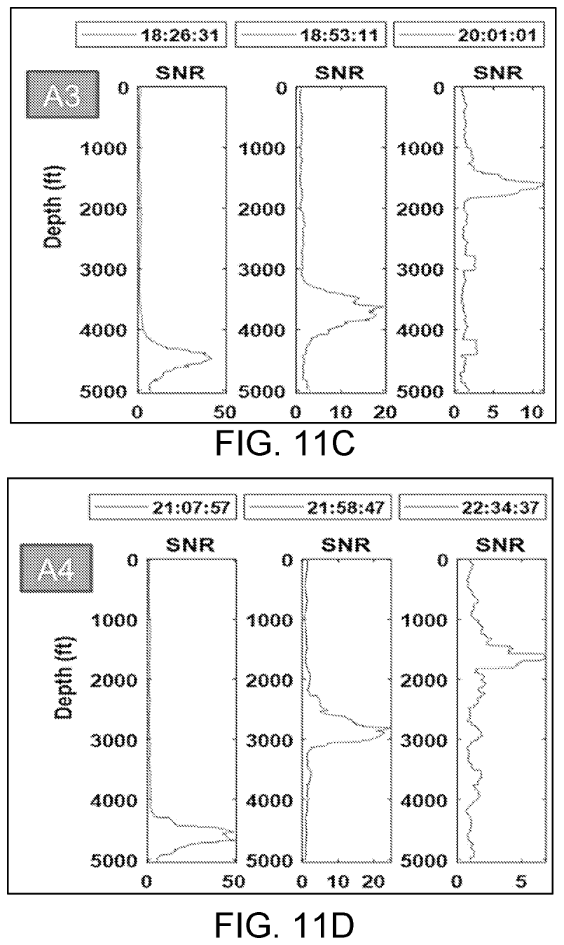

Achieving high SNR is an important consideration in the ability to detect and monitor gas kick in both static and flowing wellbore conditions. To evaluate the effect of the gas influx volume on the observed DAS signal, SNR was estimated using the FBE traces. In the present application, the desired “signal” is the gas signature, while the background noise is the acoustic signal generated by the static or circulating water and other extraneous vibration events. For the experimental trials, the background noise for each trial was selected about an hour after gas has migrated out of the wellbore, based on the observations from the DAS, DTS, and the downhole gauges. We ensured that the selected timesteps for the background (reference “noise”) were at the similar operating conditions such as circulating rates and choke position to the timesteps selected for the “signal” traces (gas presence). To estimate the SNR, the FBE values for the “signal” traces were divided by the FBE values for the background “noise” trace and then a moving window averaging filter was applied to reduce the spikiness of the curves. The SNR results for Group A trials are presented in FIGS. 11A-11D for three representative timesteps, which demonstrate the rising gas in the wellbore over time evident from the spike in the SNR versus depth curves. In all trials, the SNR reduces over time as the gas gets closer to the surface (third timestep) and higher at the deeper depth intervals (first and second timesteps) due to the dispersion of the gas phase as a result of lower pressure and gas expansion as it travels upwards in the annulus. The SNR observed in the static water column is much higher (trials A3 and A4) as compared to the trials with water circulation (A1 and A2) which increases the background acoustic noise resulting from the flowing water. The results show that the SNR is not significantly affected by the injected gas volume. For instance, the SNR over time for trials A1 (10 bbl kick) and A2 (2 bbl kick) are comparable. The SNR results provide another means to detect gas in the presence of another wellbore fluid and demonstrate that the ability to monitor gas kick is affected by the location of the gas influx along the wellbore as well as the wellbore circulation rates.

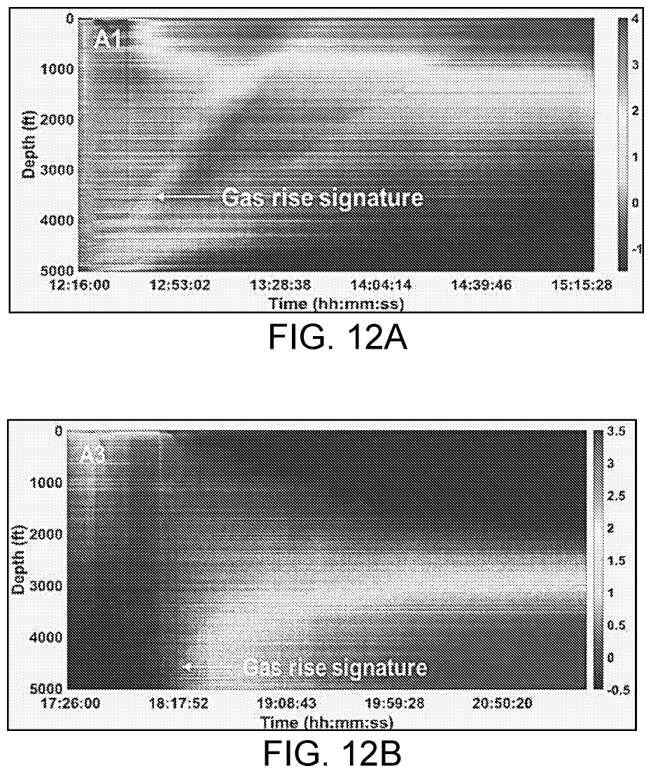

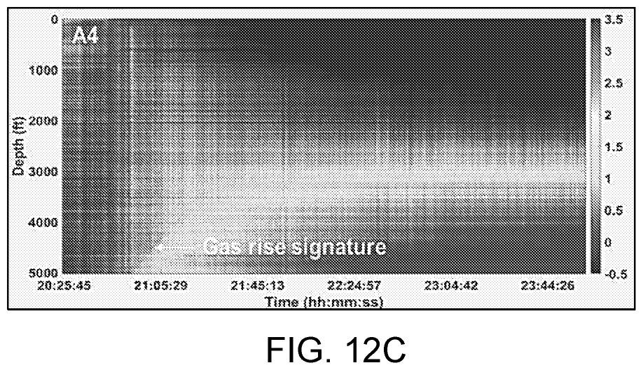

Gas signature in the DTS was visualized using difference plots in which the wellbore temperature before the gas slug injection was subtracted from the instantaneous DTS temperature data in order to capture the temperature change as the gas passes through the wellbore. The DTS difference plots showed the gas signature more clearly as compared to the DTS temperature (instantaneous) plots. The gas signature in trials A1, A3 and A4 can be seen in the DTS difference plots in FIGS. 12A-12C. DTS for trial A2 could not be obtained due to a technical issue. The gas rise signature is most clearly observed for trial A1 where the gas injection is followed by water circulation which further contributes to the change in observed temperature. In trial A1, the temperature increases close to the surface are a result of the arrival of the circulating water which is warmer than the wellbore fluid at the top. In trials A3 and A4, the gas rise signature is only observed at the bottom of the well as the gas exits the ½-in. injection line and enters the larger diameter annulus. The temperature at the bottom of the well warms up over time as a result of geothermal heating over time. The gas rise velocity was approximated from the slope of the gas signature observed in the DTS difference plots and summarized in Table 3 (FIG. 5C) in the row “DTS.” The gas velocities calculated using DAS and DTS show good agreement with the results from the numerical simulations, flow correlation, and the observations from the pressure gauge data.

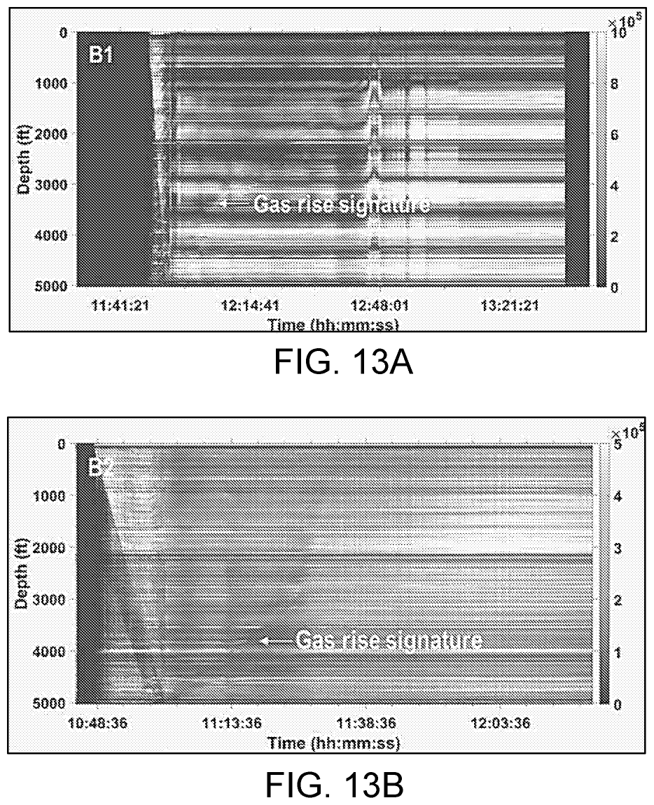

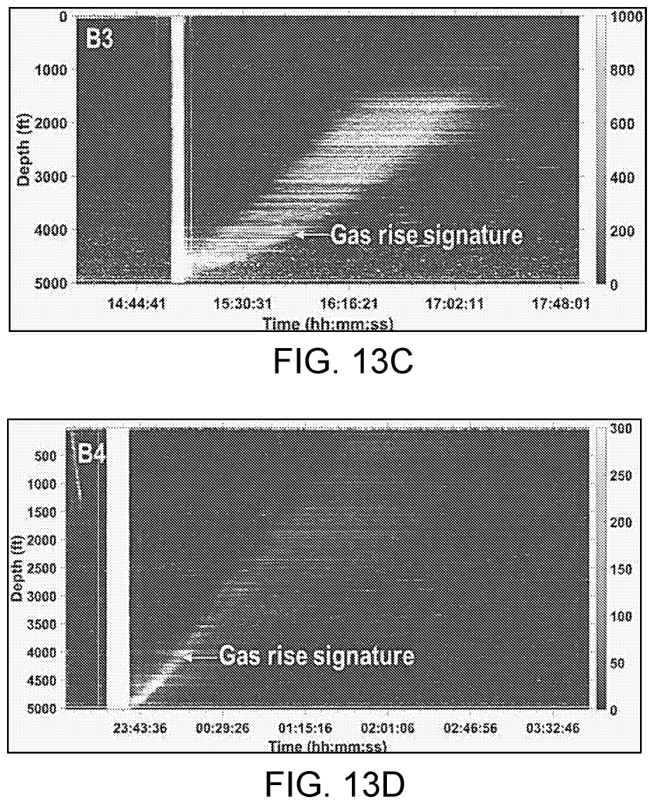

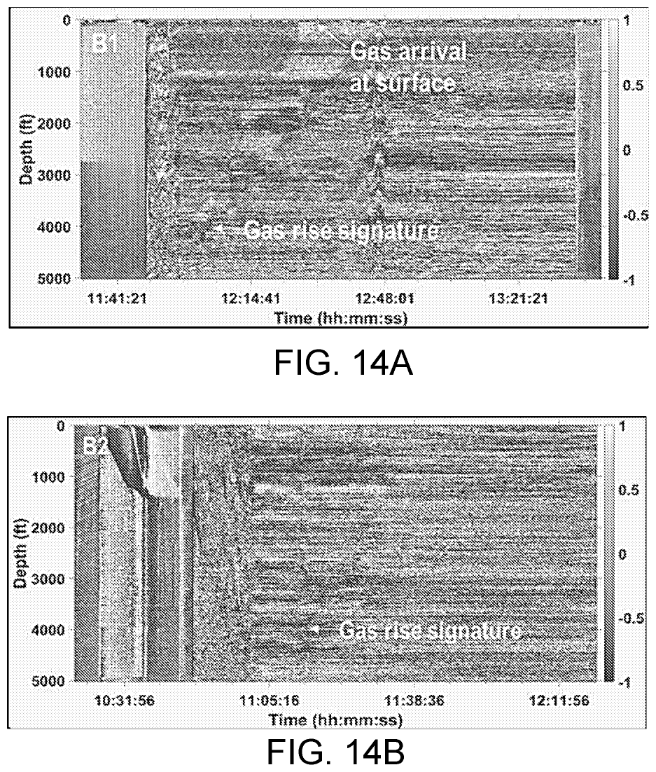

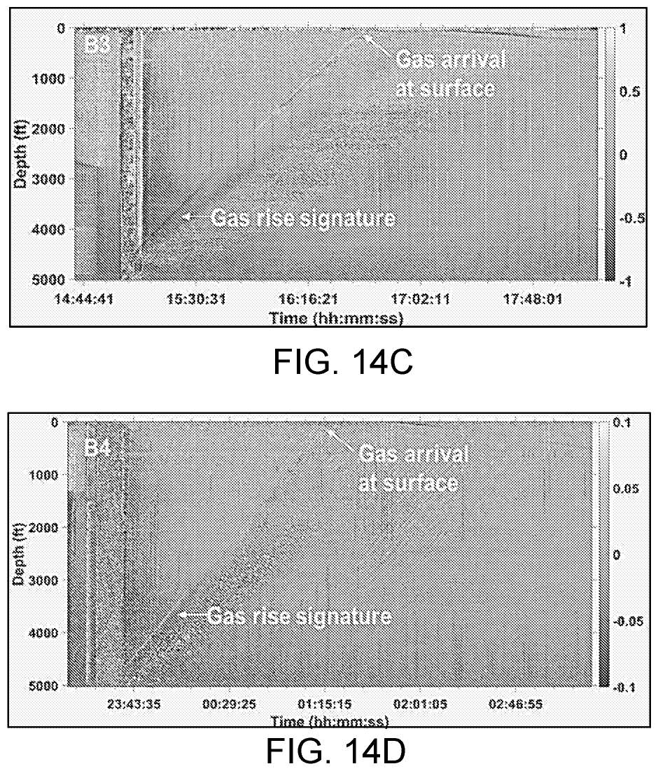

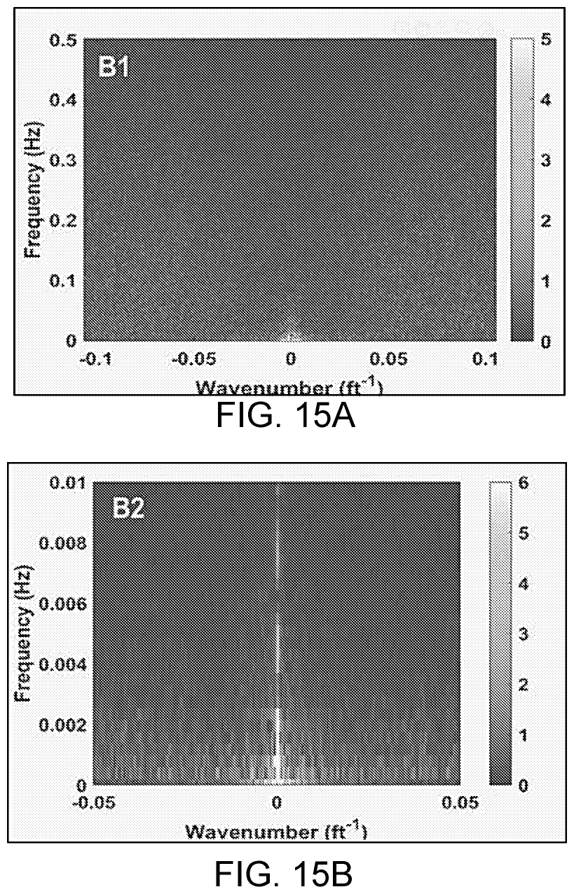

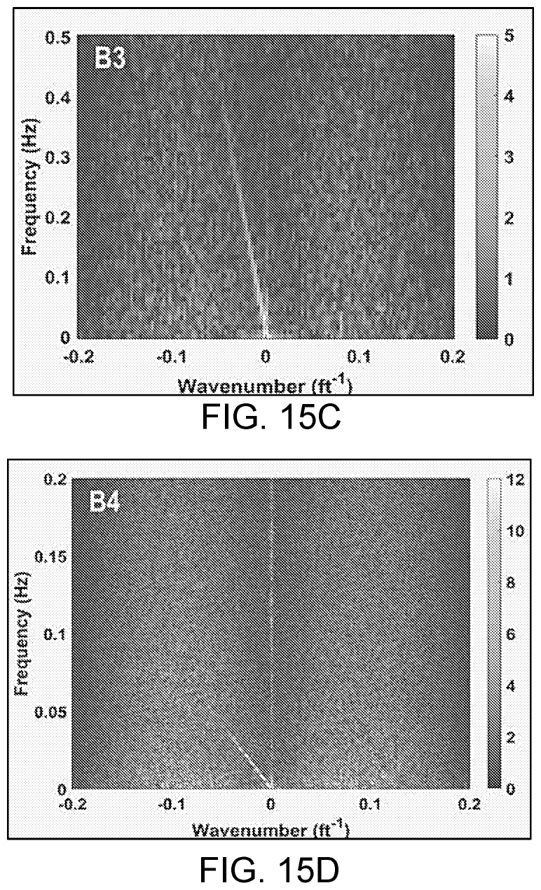

In the Group B trials, nitrogen gas was injected down the tubing and the gas rise in the annulus was observed using DAS and DTS. DAS Band 0 (2-5,000 Hz) waterfall plots for trials B1 through B4 are shown in FIGS. 13A-13D, where for a colorized depiction of the waterfall plot, the color in the plot corresponds to the intensity of the spectral power of the acoustic signal in the FBE. The signature of the rising gas is more clearly visible in trials B3 and B4, where there is no water circulation, or in other words the gas rises in a static water column. This is also consistent with the observations for the Group A trials A1 and A2. In trials B1 and B2, the gas signature is less clear due to the high acoustic/vibration signal created by the circulating water which is more evident for trial B1 due to the higher kick volume (15 bbl) combined with the higher circulation rate (200 GPM). For B1 and B2, the other high-frequency DAS FBE Band 1 (2-10 Hz), Band 2 (10-50 Hz), and Band 3 (50-200 Hz) also show very similar gas signatures, which is not as clearly seen as the case with no circulation. Injection through the tubing with water circulation results in relatively more background acoustic signal which can be observed if we compare trials B1 and B2 with trials A1 and A2. Higher gas kick volume results in a thicker gas signature which is clearly observed along the wellbore in trial B3 (15 bbl) as compared to trial B4 (5 bbl). The gas signature in all trials gets diffused at shallower depths and it is difficult to see the first gas arrival at surface in the Band 0 plots. The gradient of the LF-DAS with respect of time are compared in FIGS. 14A-14D which shows clear gas signatures for trials B3 and B4 (with no water circulation) while the signature is less clear for trials B1 and B2 due to the high-frequency effect created by the water circulation. The first arrival of gas at surface is more clearly observed in the LF-DAS for trials B3 and B4 as compared to the high-frequency DAS plots in FIGS. 13A-13D. The gas rise velocity was calculated from the slope of the F-K transform of the gradient of LF-DAS with respect to time for trials B1-B4, as presented in FIGS. 15A-15D. While the gas velocity is clearly observed for trials B3 and B4 in the F-K transform, for trials B1 and B2, a dominant gas signature is not observed, again because of the high-frequency components due to the circulation. Therefore, for trials B1 and B2, the slope of gas signature seen from DAS Band 0 data is used to approximate the gas rise velocity.

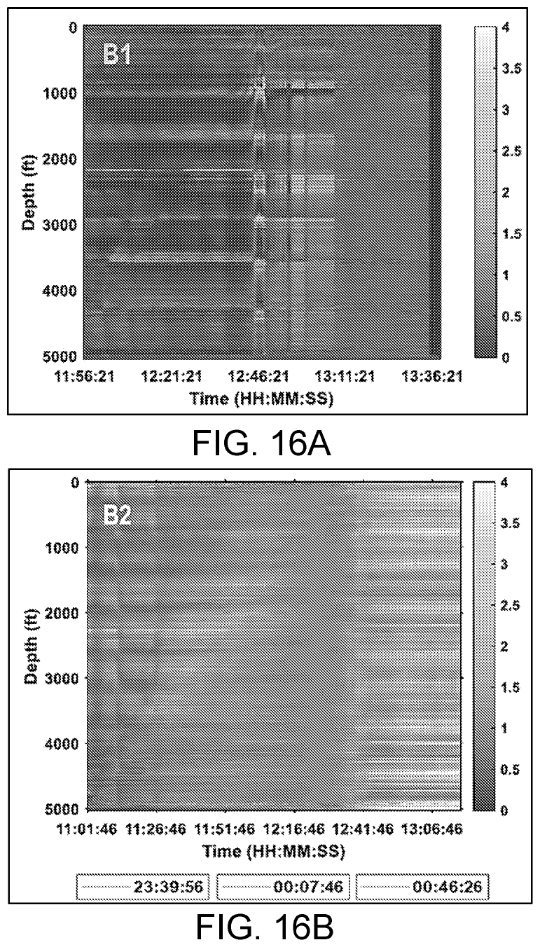

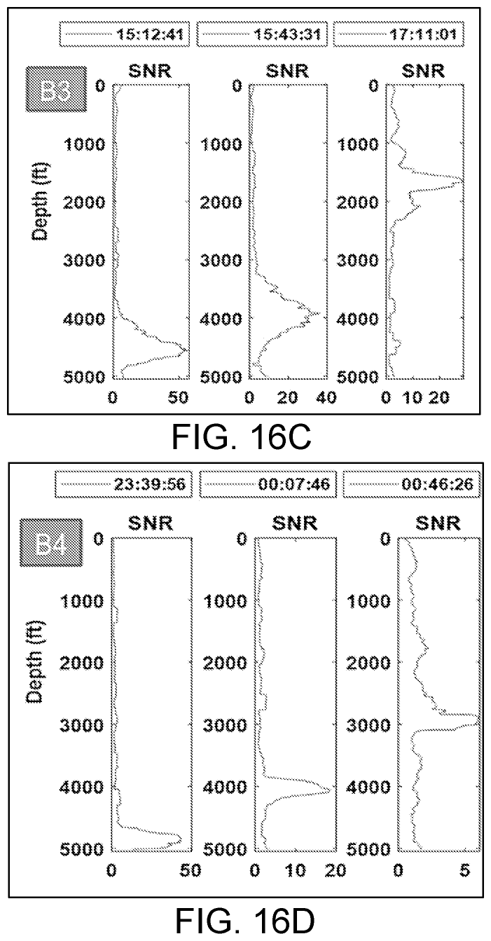

SNR was also estimated for the Group B trials using similar methodology as the Group A trials. For trials B3 and B4, the signature of rising gas was clearly evident in the SNR versus depth curves over time in FIGS. 16C-16D, which showed higher SNR at deeper intervals in the wellbore and lower SNR as the gas travelled upward and got increasingly dispersed. However, for trials B1 and B2, the SNR trace plot did not clearly show the gas movement due to the much higher background noise observed in these trials due to the injection through the tubing. Therefore, SNR waterfall plots were utilized, as shown in FIGS. 16A-16B, where instead of using just three traces, SNR was calculated for all timesteps, which show the gas rise signature and the corresponding SNR over time more clearly. The results demonstrate that the SNR and the ability to detect gas is also affected by the method of delivery—in other words, whether the gas enters the annulus through a small opening (as simulated by the injection line) or a larger formation section (as simulated by the injection through the tubing).

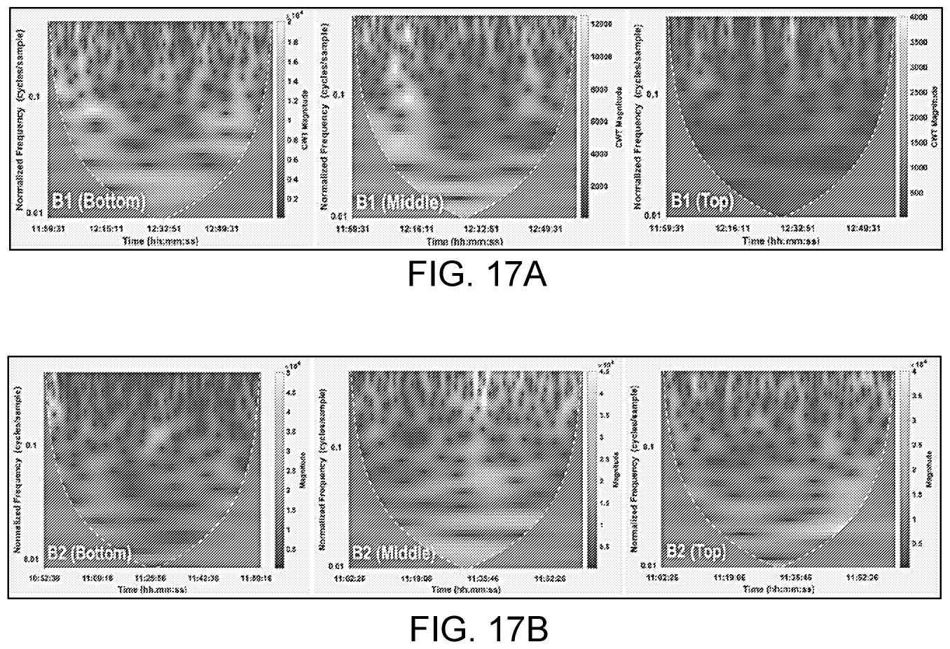

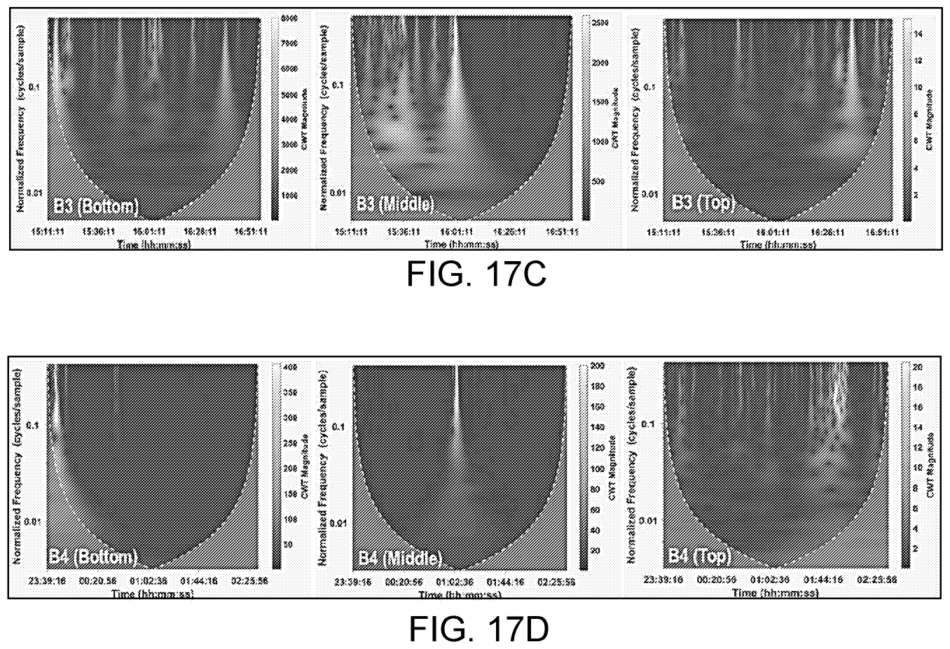

Because the gas signature was difficult to observe clearly for trials B1 and B2 in the SNR trace plots and the DAS high-frequency and low-frequency FBE waterfall plots, another approach to visualize DAS data was implemented utilizing the 1D continuous wavelet transform or CWT which offers the advantage of joint time-frequency localization at each depth interval providing more insight into the flow dynamics. A generalized Morse wavelet was used for the analysis because it is useful for analyzing signals with time-varying amplitude and frequency and localized discontinuities. The symmetry parameter (gamma) for the Morse wavelet was 3, and the time-bandwidth product was 60. FIGS. 17A-17D show the scalograms for the Group B trials which depict the absolute value of the CWT plotted as a function of time on the x-axis and frequency in cycles/sample on the y-axis in logarithmic scale. The plots represent the 1D CWT of DAS FBE (Band 0) data at three representative depths-close to the bottom, middle, and near the top of the wellbore, as the gas is rising through the annulus. The dashed white line in the scalograms represents the cone of influence where the edge effects become significant. Gray regions outside the dashed white line delineate regions where edge effects are significant.

In each plot, the high CWT magnitude (bright yellow spots in a colorized version of the scalograms or white spots in a black and white version of the scalograms) are indicative of a gas slug arrival at that depth which causes a change in the DAS energy content. For example, the scalograms for trial B3 show that the gas is close to the bottom of the tubing around 15:11 and the gas slug arrives at surface around 16:44, which is in good agreement with the DAS FBE observations in FIGS. 13A-13D and 14A-14D and the estimated velocity. For all trials, the CWT magnitudes corresponding to the gas are higher at the bottom of the well when the slug first enters the annulus, and reduce as the gas gets closer to the surface due to the gas dispersion. The lower frequencies are being attenuated as the gas reaches the top, which is also in good agreement with the FBE and LF FBE data. The gas signatures are easier to observe for trials B3 and B4 with no water circulation and relatively noisier scalograms are observed for trials B1 and B2 due to circulation. The CWT plots give another means to confirm the gas movement along the wellbore and the changing magnitudes provide a qualitative indication on the amount of gas present.

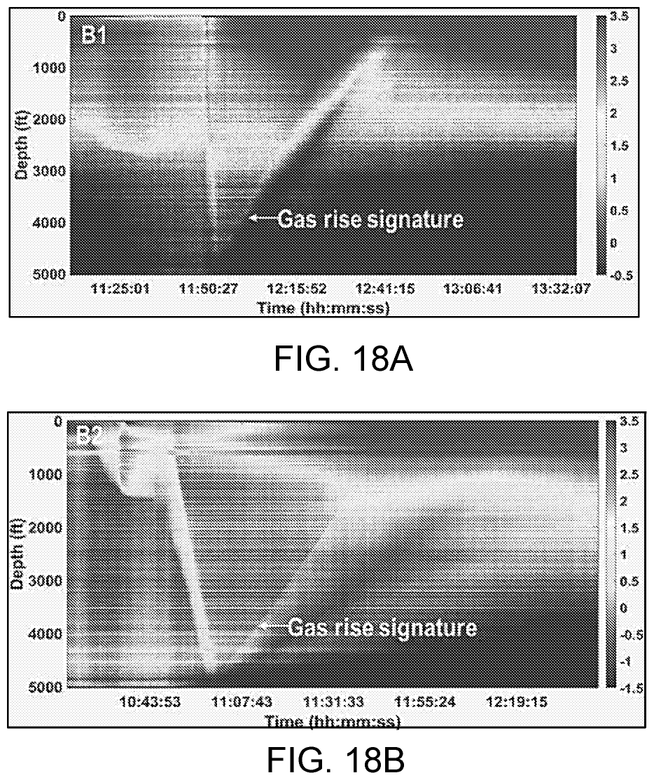

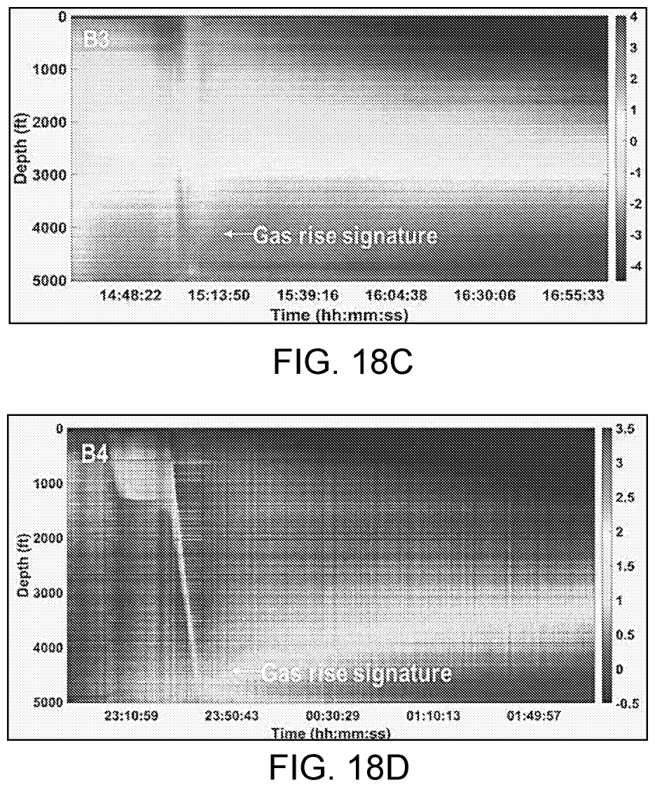

The gas rise signatures seen in the DTS difference plots are presented in FIGS. 18A-18D. Similar to the Group A analysis, to create the difference plots, the wellbore temperature prior to gas injection was subtracted from the instantaneous DTS temperature data to monitor the temperature change as the gas passes through the wellbore. Trials B1 and B2 show very clear signature for both the gas injection down the tubing and subsequent gas rise in the annulus. The warmer temperature at the top in trials B1 and B2 is the result of the temperature difference between the injected water and the wellbore fluid at the top. For trials B3 and B4, the gas rise signature is only seen at the lower depths (similar to the Group A trials A3 and A4 with no circulation) as the gas exits the tubing and enters the annulus. The gas rise velocity was estimated from the slope of the DTS difference plot and summarized in Table 3 (FIG. 5C). The gas velocities estimated from DAS and DTS show reasonable agreement with those calculated from the numerical simulations, flow correlations, and pressure gauge data.

In accordance with systems and methods of the present disclosure, distributed fiber optic sensors enable the real-time detection and monitoring of gas influx along the entire wellbore. An important application, among others, of the present disclosure is monitoring the gas in a riser using fiber-optic sensors that can lead to a better understanding of gas behavior inside the drilling riser and allow early gas kick detection at a well bottom. Accordingly, the gas rise velocities calculated independently using the DAS and DTS data show a good agreement with those estimated from the numerical model, multiphase flow correlations, and downhole pressure gauge data. Additionally, the observed gas rise velocities indicate bubble flow regime and the experimental results suggest that the volume of gas injected in the well only moderately contributes to the increase of the gas rise velocity. The effect of this parameter is important on other flow variables such as gas flow rate flowing out of the well and pressure.

In accordance with systems and methods of the present disclosure, DAS and DTS data can be analyzed using a variety of signal processing techniques to optimally detect the gas signature, including, high-frequency DAS FBE and LF-DAS phase gradient, F-K transform, SNR plots, time-frequency scalogram, energy spectrum, and DTS difference plots. As such, exemplary systems and methods for distributed fiber optic measurements and monitoring can have a direct impact on improving well control practices during drilling, completion, and workover activities in the oil and gas industry. In various embodiments, distributed real-time acoustic, temperature, and/or pressure data can provide a potential step-change to the way wells are monitored and managed as they are being drilled and may reduce exposure to incidents and improve drilling performance, especially in deep water, where the risks and consequences are significant. Thus, fiber optic sensors give the ability for early real-time detection of gas or liquid influx or kick during drilling and identify the location, which is critical for well control, whereas simultaneous monitoring along the entire well length is not possible using the conventional gauges. With the increasing use of complex oil recovery techniques such as chemical/gas/steam injection and challenging logistics, especially in offshore and subsea operating environments, the knowledge of real-time downhole measurement along the entire well can provide an additional safety measure to prevent well control incidents. More quantitative gas influx characterization can be achieved using a data assimilation method with distributed fiber optic measurements along with other measurements in real time. This method combines a physics-based two-phase flow model with real-time measurements, which include conventional (both surface and downhole) measurements, and distributed fiber optic measurements, to achieve real-time estimation of states (e.g. pressure, gas and liquid velocities and fractions in a wellbore or a riser) and unknown parameters (e.g. influx rate). In various embodiments, a Kalman Filter-based data assimilation process can be divided into two steps, a prediction step and an updating step. At every time step, the previous estimate of the parameters is used in the Kalman Filters as a given (known) input, and a prediction is made by running a two-phase flow model. As the new measurements become available, they will be used in the update step to update the model prediction results. During this process, the empirical coefficients of the two-phase flow model (e.g. the slip coefficients and friction coefficients), the unknown parameters that are required for model input (e.g. the downhole gas influx rate), as well as the uncertainty quantification (described with a covariance matrix where variance values represent the uncertainty of each state parameter, and the covariances represent the dependency of the parameters on each other) of the system will be updated based on real-time measurements by calculating the Kalman Gain Matrix at each time step.

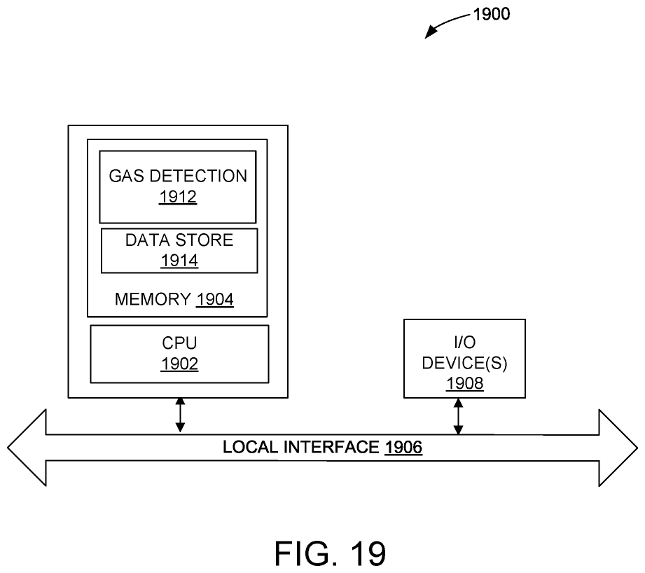

FIG. 19 depicts a schematic block diagram of a computing device 1900 that can be used to implement various embodiments of the present disclosure, such as but not limited to a surveillance computing device. An exemplary computing device 1900 includes at least one processor circuit, for example, having a processor (CPU) 1902 and a memory 1904, both of which are coupled to a local interface 1906, and one or more input and output (I/O) devices 1908. The local interface 1906 may comprise, for example, a data bus with an accompanying address/control bus or other bus structure as can be appreciated. The CPU can perform various operations including any of the various operations described herein.

Stored in the memory 1904 are both data and several components that are executable by the processor 1902. In particular, stored in the memory 1904 and executable by the processor 1902 are various gas detection routine(s) 1912 in accordance with embodiments of the present disclosure. Also stored in the memory 1904 may be a data store 1914 and other data. The data store 1914 can include sensor data recordings, and potentially other data. In addition, an operating system may be stored in the memory 1904 and executable by the processor 1902. The I/O devices 1908 may include input devices, for example but not limited to, a keyboard, touchscreen, mouse, recording devices, and/or sensors, such as fiber optic sensors, interrogator units, etc. Furthermore, the I/O devices 1908 may also include output devices, for example but not limited to, a display, speaker, earbuds, audio output port, a printer, communication adapters, etc.

Certain embodiments of the present disclosure can be implemented in hardware, software, firmware, or a combination thereof. If implemented in software, gas detection logic or functionality, in accordance with embodiments of the present disclosure, are implemented in software or firmware that is stored in a memory and that is executed by a suitable instruction execution system. If implemented in hardware, the gas detection logic or functionality can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, at least the following is claimed:

1. A method comprising:
positioning a fiber optic sensor along a length of a wellbore or a wellbore structure positioned within the wellbore, wherein the fiber optic sensor comprises an optical cable;
obtaining, by a computing device, fiber optic sensing data acquired by the fiber optic sensor and an optical interrogator;
processing, by the computing device, the fiber optic sensing data to identify a multiphase fluid flow or a gas signature of gas within the wellbore;
tracking, by the computing device, a movement of the gas along the length of the optical cable by determining a flow velocity of the moving gas or a lower density phase of the moving gas with respect to a surrounding fluid;
detecting, by the computing device, a presence of the moving gas towards a surface of the wellbore or a surface of the wellbore structure; and
transmitting, by the computing device, a control signal to a controller of machinery operating in the wellbore after detecting the presence of the moving gas.

2. The method of claim 1, wherein the fiber optic sensor comprises a distributed acoustic sensor.

3. The method of claim 1, wherein the fiber optic sensor comprises a distributed temperature sensor.

4. The method of claim 1, further comprising predicting, by the computing device, an arrival time that the gas will reach the surface of the wellbore based on the determined flow velocity.

5. The method of claim 1, wherein the flow velocity is determined using a numerical model that simulates a bullheading operation occurring in the wellbore.

6. The method of claim 1, wherein the flow velocity is determined using a numerical model that simulates an injection line operation occurring in the wellbore.

7. The method of claim 1, wherein the flow velocity is determined using a numerical model that simulates a migration condition occurring in the wellbore.

8. The method of claim 1, wherein the flow velocity is determined using signal-to-noise analysis of the fiber optic sensing data, wherein the fiber optic sensing data comprises distributed acoustic sensor data.

9. The method of claim 1, wherein the flow velocity is determined using an analysis of an energy spectrum of the fiber optic sensing data, wherein the fiber optic sensing data comprises distributed acoustic sensor data.

10. The method of claim 1, wherein the flow velocity is determined using a frequency-wavenumber transform of a gradient of a frequency band energy of distributed acoustic sensor data over time.

11. The method of claim 10, wherein a frequency of the distributed acoustic sensor data is between 0 and 2 Hz.

12. The method of claim 9, wherein the flow velocity is determined using a 1D continuous wavelet transform of the energy spectrum.

13. The method of claim 12, wherein a frequency of the distributed acoustic sensor data is between 2 and 5000 Hz.

14. The method of claim 1, wherein the flow velocity is determined using an analysis of a difference plots for a temperature of the moving gas, wherein the fiber optic sensing data comprises distributed temperature sensor data.

15. The method of claim 1, wherein the controller is part of a control system for drilling operations of the wellbore.

16. The method of claim 1, wherein the controller is part of a control system for managed pressure drilling operations of the wellbore.

17. The method of claim 1, wherein the control signal directs the controller to adjust an operational parameter of the machinery operating in the wellbore.

18. A system comprising:
at least one processor; and
memory configured to communicate with the at least one processor, wherein the memory stores instructions that, in response to execution by the at least one processor, cause the at least one processor to perform operations comprising:
obtaining fiber optic sensing data acquired by a fiber optic sensor positioned along a length of a wellbore or a wellbore structure positioned within the wellbore, wherein the fiber optic sensor comprises an optical cable;
processing the fiber optic sensing data to identify a multiphase fluid flow or a gas signature of gas within the wellbore or the wellbore structure;
tracking a movement of the gas along the length of the optical cable by determining a flow velocity of the moving gas or a lower density phase of the moving gas with respect to a surrounding fluid;
detecting a presence of the moving gas towards a surface of the wellbore or a surface of the wellbore structure; and
transmitting a control signal to a controller of machinery operating in the wellbore after detecting the presence of the moving gas.

19. The system of claim 18, wherein the fiber optic sensing data comprises distributed acoustic sensor data.

20. The system of claim 18, wherein the fiber optic sensing data comprises distributed temperature sensor data.
